(19) United States
(12) Patent Application Publication
(10) Pub. No.: US 2001/0034756 A1
(43) Pub. Date: Oct. 25, 2001

(54) Standard operating procedure (SOP)-driven digital network architecture (DNA)

(76) Inventors: Flora Kan, Gaithersburg, MD (US); David Kan, Gaithersburg, MD (US); Andrei Kitchaev, Rockville, MD (US)

Correspondence Address: Data Unlimited International, Inc., 362A Christopher Ave., Gaithersburg, MD, 20879, US

(21) Appl. No.: 09/754,425

(22) Filed: Jan. 4, 2001

Related U.S. Application Data
(60) Provisional application No. 60/199,552, filed on Apr. 25, 2000.

(51) Int. Cl. G06F 15/16

(52) U.S. Cl. 709/203; 709/205

(57) ABSTRACT

Standard Operating Procedure (SOP)-driven Digital Network Architecture monitors, tracks laboratory routines and creates electronic records. The invention enables laboratory scientists to design, manage, control, and reproduce laboratory routines. The invention creates electronic system to identify where, who and when the quality deteriorates in laboratories. SOPs mean instructions of which texts for scientists and directives for computers. Methods include two mutual computer-aided processes—SOP management and laboratory routine. Both processes start with user authentication, security group, security access to SOPs and laboratory routine. Further SOP management that may not be subsequent is defining and refining contents of SOPs; version control, retirement and assignment of SOP to specimens. Further laboratory routine that must be subsequent include assigning SOPs to checked-in specimen, chain of custody; test results based upon SOPs; repeating the steps according to SOPs and forming chain of custody, test results; case approval and closing the case.

### BACKGROUND OF THE INVENTION

This invention relates generally to the laboratory information management systems and specifically to the laboratory routines performed using computational infrastructure. The invention enables the digital business rules and implementations of the Standard Operating Procedures (SOPs) to perform the quality control and quality assurance. An SOP is an organizationally approved series of instructions for the laboratory scientists to follow to perform the laboratory routines.

Recent advances in the bioscience, including genomic discovery, cell biology and pharmaceuticals have brought drugs, therapies, diagnostics and medical treatment. They have generated vast amounts of data. The industry needs a computational infrastructure that enables the proven business rules governing the laboratory routines and the implementation permitting faster access and error elimination.

The problem to which the invention is directed was approached on a paper-based operation previously. The situation is described below.

Case Accessioning—The following activities take place during this step.

Acceptance of a specimen

Establishment of a case file holder

Establishment of a chain of custody

Entry of basic demographic information about the case in various logs

Assignment of laboratory scientists to the case

Assignment of a case number

Laboratory Routines—This step constitutes the bulk of the case analysis and consists of both specified laboratory procedures and interpretation of laboratory results. This step can be divided into the following sub-steps:

Creation of images of case specimens

Preparing specimens for laboratory routines according to SOPs

Performing analysis and data interpretation according to SOPs

Report Writing—After obtaining the final results of laboratory routines, the laboratory scientists will make a determination, write a preliminary report, and submit the report into the review process.

Review—Designated senior laboratory scientists conduct a thorough review of the findings and, if they concur with the findings, approve the final report.

Final Report Processing—A final report is distributed to the person/agency that requested the testing. Additional copies are placed into the case folders.

Storage—The complete case file folders are stored physically.

Due to the scientific empirical nature of laboratory analysis, these paper files can be voluminous. The paper-based operation is at or near its capacity to accurately record and track cases. The FIG. 1 illustrates the paper-based operation.

Little inherent flexibility exists in the current paper-based system to accommodate increased workload or continuous refinements in the analysis process; the current system is not an efficient means of managing the laboratory routines that generates a large amount of data and provides few analysis or management tools. All documentation and reporting is paper-based, including case archives. There is no convenient method for searching previous cases for data or for generating statistical reports.

Because of the paper-intensive laboratory routines, senior laboratory scientists have few tools to track the efficiency of laboratory procedures and the scientists' practice patterns. Management oversight requires countless hours and days spent reviewing paper cases. Because of the paper media currently utilized to capture and store case data, retrieval of specific information for research or educational purposes is difficult.

Therefore, the invention suggests the SOP-driven digital network architecture of business rules and implementation to govern the laboratory routines, to eliminate clerical transcription errors, to collect data and to control the quality.

### SUMMARY OF THE INVENTION

In accordance with this invention, SOP-driven Digital Network Architecture (DNA) includes at least a computer server and at least a computer client. Computer client is a software and/or hardware that ask for access. Computer server is a software and/or hardware that provide access.

The computer server has the database of the series of instructions for laboratory scientists and computer commands to perform laboratory or laboratory-related processes. The computer server is able to authenticate users and exchange the data via communication links. Upon the requests from the computer clients, the computer server will provide the series of instructions for laboratory scientists and computer commands to guide through the laboratory or laboratory-related routines. The computer server is able to store the work data of in-progress and completion resulted from the series of instructions for laboratory scientists and computer commands.

The computer client has a user interface to allow laboratory scientists to log in and to be authenticated by the computer server. The user interface enables the input of the series of instructions for the laboratory scientists and computer commands. The user interface enables laboratory scientists to select a pre-defined series of instructions and computer commands based upon the laboratory or laboratory-related routines. The user interface will guide, suggest and prompt the laboratory scientists based upon the selected series of instructions and computer commands. The user interface will post a transaction to the databases of the computer server to store the work data that are in process or complete.

Further in accordance with this invention, a method enables the creation of the security groups of laboratory scientists with discretionary security access rights to the areas of the user interface and the databases.

Still further in accordance with this invention, a method enables the scientists to create, identify and distinguish the types of pre-defined instructions and computer commands to connect to laboratory or laboratory-related routines.

Still further in accordance with this invention, a method enables the laboratory scientists to study and analyze the collections of the pre-defined instructions and computer commands via searching, sorting and reporting.

Still further in accordance with this invention, a method enables the maintenance of the database transactions of pre-defined instructions and computer commands.

Still further in accordance with this invention, a method allows the input of the pre-defined instructions and computer commands. A method allows executing the computer commands as part of a series of the instructions. A method allows connecting series of pre-defined instructions and computer commands.

Still further in accordance with this invention, a method enables connecting series of pre-defined instructions and computer commands to laboratory or laboratory-related routines.

Features and capabilities described in the specification are not all-inclusive, and particularly, many additional features and capabilities will be apparent to one of ordinary skills in the art in view of the drawings, specification, and claims hereof.

Moreover, it should be noted that the language used in the specification has been principally selected for the readability and instructional purposes, and may not have been selected to delineate or circumscribe the inventive subject matter, resort to the claims being necessary to determine such inventive subject matter.

### OBJECTS AND ADVANTAGES OF THE INVENTION

The primary object of this invention is to provide a method that enables the creation and execution of the instructions for laboratory scientists to follow to perform laboratory routines.

Other objects that this invention accomplishes include:

1. Define and refine flexibly the laboratory or laboratory-related routines

2. Eliminate the paper-based operation

3. Provide a means of managing the laboratory routines and data via the computer searching, sorting and reporting capability

4. Provide electronic record management method

5. Provide the access to the real-time management oversight

6. Support the expert witness for the court testimony

Advantages over the previous approach:

Provide pre-defined instructions and computer commands to estimate costs, to predict results, to trace performance, to prevent mistakes, to simulate, to document innovative laboratory methods, to reconstruct laboratory routines and to develop future laboratory methods.

Use the computing capability of availability, reliability, reproducibility, repeatability, traceability, security, and the speed to execute the pre-defined instructions and computer commands

Standardize laboratory routines based on the pre-defined instructions and computer commands electronically to standardize laboratory routines

Build organizational collection of pre-defined instructions and computer commands to educate personnel, to transfer knowledge, to re-use experience and to conduct the intelligence analysis.

Further objects and advantages of this invention will become apparent from a consideration of the drawings and ensuing description.

### BRIEF DESCRIPTION OF THE DRAWINGS

FIG. 1 is an illustration of how the problem to which this invention is directed was approached previously.

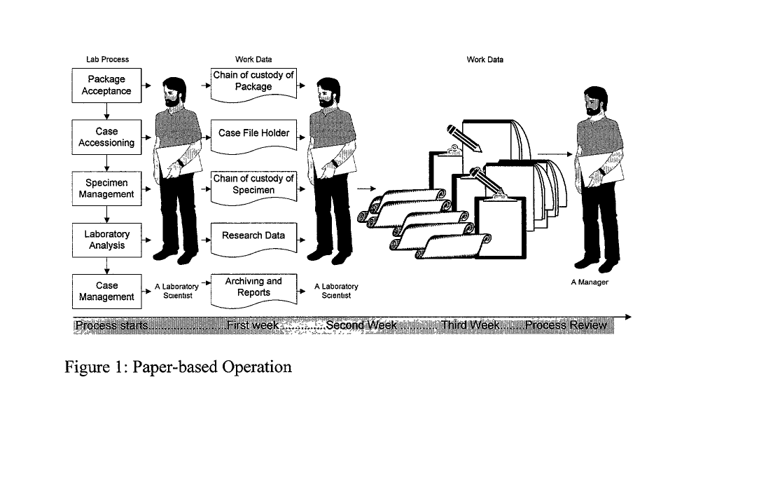

FIG. 2 presents the scheme of the database system of Standard Operating

Procedure (SOP)-driven Digital Network Architecture.

FIG. 3 is a flowchart illustrating the method to define the security access rights.

FIG. 4 shows how SOP drives laboratory routines.

FIG. 5 is an organization diagram illustrating laboratory routines.

### DESCRIPTION OF THE INVENTION

Method may be realized by means of a general computer server and at least one computer client in conjunction with especially designed software. Server is a computer that provides some service for other computers connected to it via network. The connection between client and server is by means of message passing over a local area network (LAN) or through Internet, and uses corresponding messaging protocol to encode and decode the client's requests and server's responses. The server should include the database used to store, manipulate and retrieve the information. Database can be implemented on a variety of commercially available database packages. A common graphic user interface is software that has to be executed at every computer client to conduct operation of the invented method.

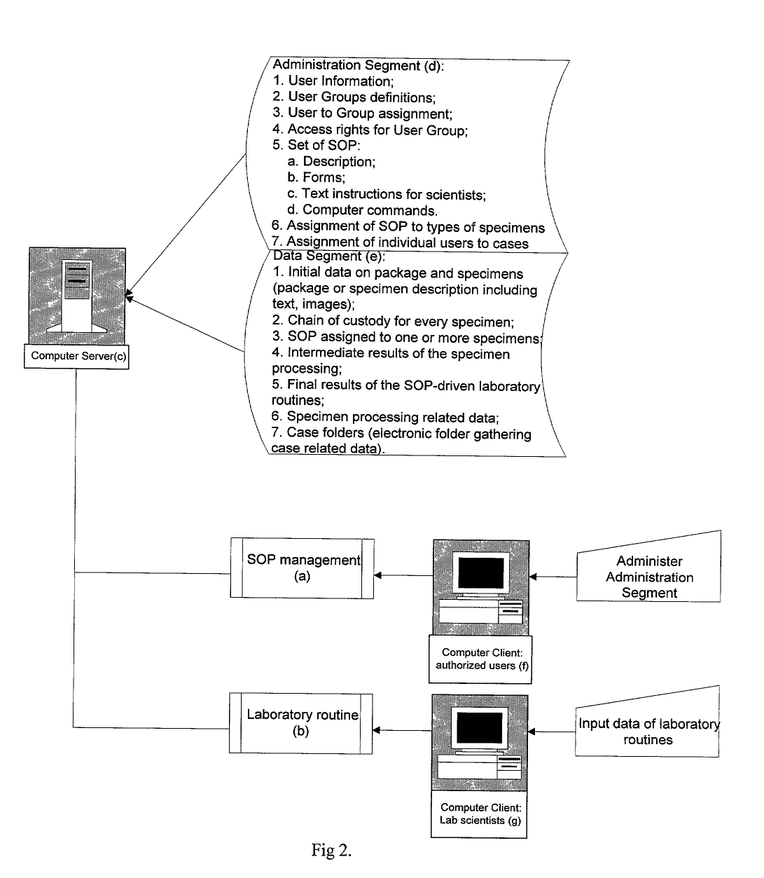

Method comprises two types of mutually related computer-aided processes: SOP (Standard Operating Procedure) management (FIG. 2(a)) and laboratory routine (FIG. 2(b)). Here and below the Standard Operating Procedure means the set of stored in the database instructions for users and computer commands. Human instructions include text descriptions and forms placed in a predefined sequence.

Both processes physically are the retrieving, adding or modification of data in the database. They are fulfilled during the interaction of a single user from a computer client with a database running at server.

The computer server (FIG. 2(c)) contains the following general segments with structured information stored in the database:

I. Administration Segments (FIG. 2(d)):

User Information—general personal information and login that includes username and password and/or biometrics data (electronic signature), allowing authenticate user.

### Definitions of User Groups:

User to Group assignment—information on user belonging to user group or groups. Access rights for User Group—security definitions of the user group's rights and privileges.

Set of SOP—each of them includes human instructions with text and forms placed in a predefined sequence and may include computer commands.

Assignments of the SOP to the types of specimen.

Assignment of individual users to the case folder.

II. Data Segments (FIG. 2(e)):

Initial data (package and/or specimen description including text, images and standard classification attributes);

Chain of custody for every specimen;

SOP assigned to the specimen or group of specimens;

Intermediate results of the specimen processing;

Final results of laboratory routines prescribed by the SOPs and filled by laboratory scientists;

Specimen Processing Related Data—such as location of storage, chemicals and equipment used to process specimen etc.;

Case folder (electronic folder joining together all case related information including the data, arbitrarily chosen by user).

The data of the Administration Segment in the FIG. 2(d) shall be administered and input by users that are authorized to access this segment. It is illustrated by “Computer Client: authorized users (FIG. 2(f)).” The laboratory scientists that are illustrated by “Computer Client: lab scientists (FIG. 2(g))” will input the data of the Data Segment (FIG. 2(e)).

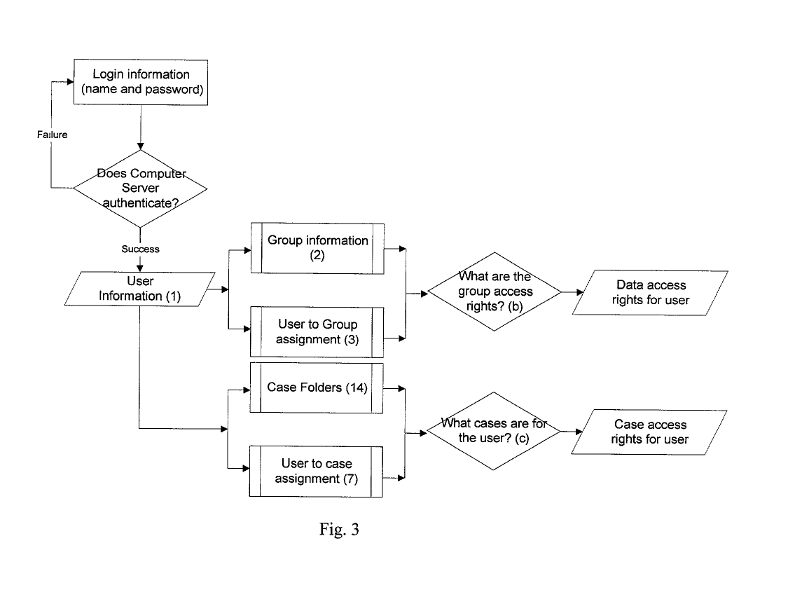

According to claims 1-ii and 3 invented method provides a differentiated level of security access to the data segments and means to pre-define the groups of users with discretionary access rights. The underlying mechanism is shown on FIG. 3, numbers on a diagram correspond to those that enumerate the database segments on FIG. 2.

Mechanism uses security features of the database software that allow database administrators to manage user's access to every database table and their rights to modify data in that table. Additionally to the user identification and his or her roles defined at the level of the database, this mechanism uses the security level of a user interface of the computer client and that is called client application.

After logging in and successful authentication of a user (FIG. 3(a)), client application inquiries the database to find out what groups and cases current user is assigned to. This will determine the group access rights (FIG. 3(b)) to allow access in the Graphical User Interface (GUI) at client computer. Respectively, the restricted informational segments will not appear on a GUI and read-only areas will allow only view the non-editable information. Analogously, the determining of a case access (FIG. 3(c)) gives a list of case folders available for a given user. Thus, the appearance of the GUI at client computer varies in dependence on access rights of a user group or groups.

Main features of the described mechanism of the differentiation in access rights: Rights of user groups are defined in terms of data segments—at more global and structured level than establishment of user or user group rights for every table at database server;

Access rights management is a part of GUI at computer client, available for the members of such groups as laboratory supervisors/managers who may not necessarily have special skills for database administration. They may allow or restrict the access to the data segments without knowing of table names or data structure.

Rights of user access may vary within the limits of one database table. As system is designed to provide individually dependent data for every user, the available information on laboratory routines and their results are selected basing on the “Determining of Case Access” (FIG. 3(c) resulting from the “Assignment of individual Users to the Case Folders” (FIG. 2(7)). GUI is being built individually at client computer in accordance with access rights of group or groups that current user is assigned to.

As it was stated in the beginning of the description of the invention, two mutually related computer processes: SOP management and laboratory routine constitute the entity of the invented method. Both processes start from the steps of getting the access rights for the logged user according to described mechanism. These steps are as follows:

Server authentication of user;

Determining of security group or groups that current user is assigned to;

Obtaining the level of security access (Write, Read Only or None) of the logged user for every enumerated below process or process part that are reflected as data segments in the database and GUI.

Further parts of the SOP management process, that may not necessarily be subsequent, are:

Defining and refining the SOP contents;

Version control: creating a new SOP and a new version of the existing SOP;

retirement of the obsolete SOPs.

Assignment of SOP or SOP set to the types of specimens.

Further parts of the laboratory routine process, that have to be subsequent, are:

Entering the initial specimen information including first member of the custody chain;

Assignment of SOP to the specimen or group of specimens;

Entering the intermediate results according to the assigned SOP and specimen transfer to the next member of the custody chain;

The number of times of repeating process—entering the intermediate results and specimen transfer to the next member of custody chain—depends on the assigned SOP. That forms the chain of custody and contents of the case folder;

Typing the final result, approval and closing the case folder.

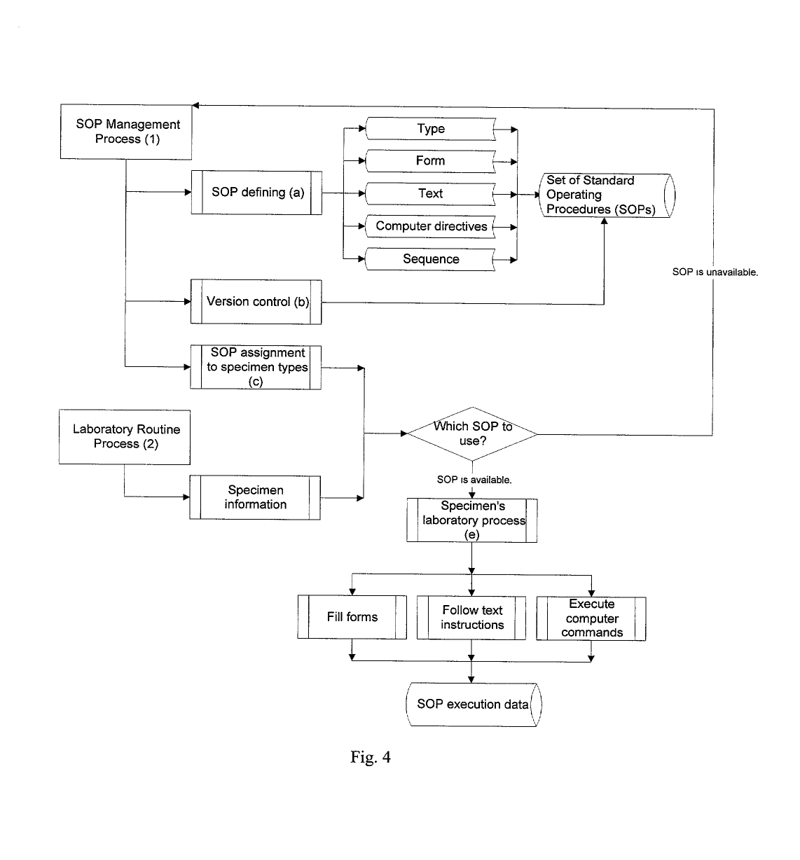

The object model of the system implementing the invented method is illustrated on FIG. 4. It shows in detail the SOP management process (1) and its interaction with the laboratory routine processes (2).

“SOP defining” module (FIG. 4(a)) suggests the determination of the SOP content: type of SOP, forms that need to be filled sequentially to complete the SOP, text with the additional instructions for users or comments. Computer commands could be written as part of SOP if the created procedure should have features like gathering data (files) from instrumental interface of any device attached to the computer client. Sequence is an essential part of the SOP. It defines the order in which the SOP data will appear at the GUI of a computer client and this order is required in the fulfillment of the prescribed operations.

“Version control” module (FIG. 4(b)) includes creating the new version of the existing SOP and retirement of the obsolete SOP. Version control expands on the entire system preventing from using different versions of the same SOP. Particularly, only one version of the SOP can be active and may be in use.

“The SOP assignment to specimen types” (FIG.4(c)) establish relations between the predefined types of the specimens and SOP.

The laboratory routine itself starts from “assignment of SOP to the specimen or group of specimens” (FIG. 4(d)). At this stage the SOP is chosen from the list of SOPs available for that type of specimen. It is intended to provide technical and organizational instructions on the processing of specimen and includes the descriptions of all operations of the specimen analysis. Forms may be included if necessary to document the process and as a container to put the intermediate and final results in. If the computer commands are included to the SOP, they are being executed at the predefined step of the SOP fulfillment requiring data input from user or gathering data from the instrumental interface.

The final aim of the described object model is shown as a rectangle (e) in FIG. 4—that are the SOP-prescribed user actions and computer commands, specific for every type of specimen. Instructions and forms that have to be filled determine user actions.

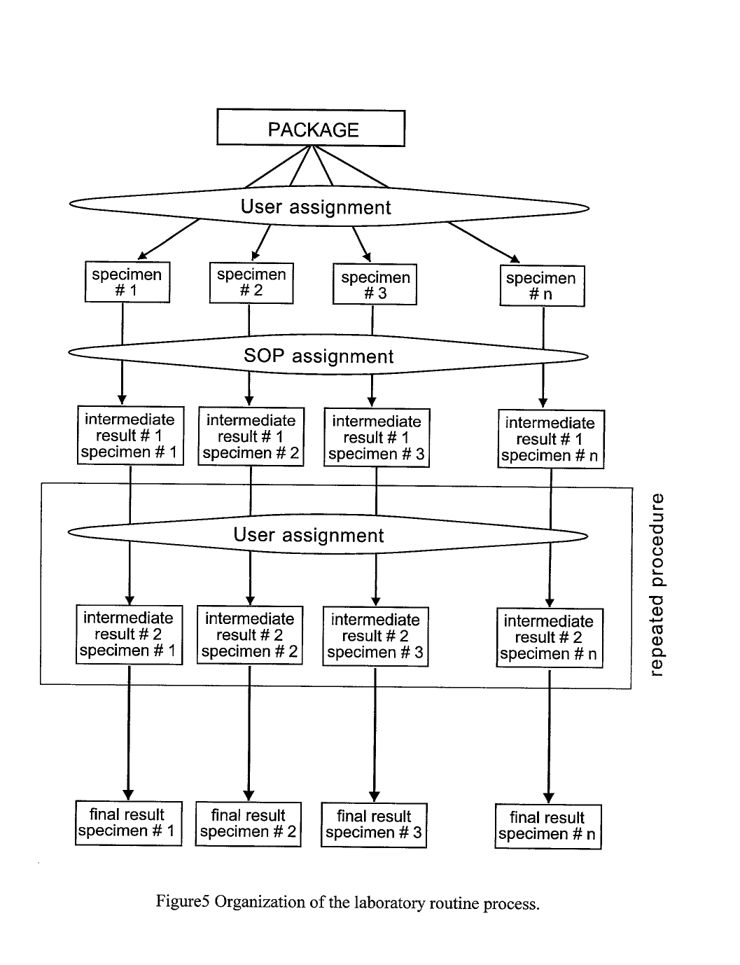

The scheme of laboratory routine workflow is illustrated in FIG. 5. The process starts from the logging of the specimen or specimens to the system and assignment of user and SOP to each of them (SOP assignment corresponds to FIG. 4(d)). The first informational block—“Package” is optional and serves as a tool to combine and store the information about specimen's origination: sender name and address, identification numbers, name of delivery service, image and etc. Following to the assigned SOP, actions are executed under the specimen and intermediate results, having the form of text, image and/or filled prescribed form, are stored in the database. Further, the next personal assignment follows and next step of the SOP is fulfilled resulting in the record of the next intermediate result in the database. This procedure is repeated the number of times dependent on assigned SOP until the SOP is complete. All the information regarding particular specimen form the chain of custody of that specimen. The chain of custody along with intermediate and final results, assigned SOP and information on specimen origination build the case folder content. Finally the case folder is the subject of approval, closing and archiving.

### Advantages

From the description above, a number of advantages of the invention become evident:

The availability of electronic SOPs using computer networks enables the access to the organizational standard without the geographical limitation. Different scientists at different places can access the standard SOPs.

The scalability of electronic SOP management using computer networks enables the efficient, accurate and synchronized version control and approval processes. Managing SOPs becomes possible to update, deactivate, activate at different scale and at scheduled timelines within the organization computer networks.

The reliability of electronic SOP management using computer networks enables replication of SOPs and the related data to recover from disaster. As opposed to relying on paper storage, the electronic SOPs and related data can be duplicated in different media formats to assure the permanent archival and future transformation. The repeatability of the electronic SOPs and the data gathered via executing SOPs using computer networks enables the capability of dataflow tracing. The computational infrastructure of the management of electronic SOPs, the execution of SOPs, the association between SOPs and the data that result from the execution of the SOPs creates an automated computer environment that monitors, guides and standardizes the business operation. Conclusion, Ramifications and Scope of Invention

Accordingly, the reader will see that the SOP-driven digital network architecture of this invention is a computational environment that:

1. Assist in the compliance with the Good Laboratory Practice (GLP)

2. Manage the laboratory routines using a set of standard procedures

3. Simulate laboratory routines

4. Estimate the cost of laboratory routines

5. Manage the laboratory risk

6. Troubleshoot errors

7. Train the laboratory scientists

8. Maintain the historical data

9. Build statistics

10. Re-construct the laboratory routines

11. Re-produce the errors

12. Quality assure the laboratory performance

13. Document the innovative intellectual processes

While the above description contains many specifications, these should not be construed as limitations on the scope of invention, but rather as an exemplification of one preferred embodiment thereof. Many computer networks comprising computer servers, computer clients and GUIs can be designed to use the method of the invention. For example, the computer server can use different operating systems with various computer clients; using different computer programming languages can develop computer client user interface.

Accordingly, the scope of the invention should be determined not by the description of the invention, but by the claims and their equivalents.

1. A method of designing, managing and controlling laboratory routines, comprising:
Providing at least a computer server that is able to
i. Store databases of the series of human instructions and computer commands to perform laboratory or laboratory-related processes;
ii. Authenticate users and provide the differentiated level of access to the informational segments;
iii. Direct and prompt users to identify and perform a laboratory process;
iv. Store the work data resulted from claim 1-i.

2. Providing at least a computer client that is able to
i. Support user interaction with computer server through graphical user interface;
ii. Input the user-designed series of human instructions and computer commands for laboratory scientists and computer commands;
iii. Enable users to select a series of instructions for laboratory scientists and computer commands;
iv. Respond to and complete the said series of instructions and commands;
v. Input the work data resulted from claim 2-iii.

3. Providing means to pre-define the groups of laboratory scientists with discretionary security access rights;

4. Providing means to manage the series of said pre-defined instructions and computer commands including:
i. Classify the types of said series and determination of the final aims;
ii. Input the instructions for laboratory scientists and update the existing ones;
iii. Associate the instructions and computer commands with laboratory or laboratory-related processes;
iv. Determine the sequence of instructions and computer commands in the series;
V. Manage and document the evolution history and audit trail of a pre-defined human instructions and computer commands;

5. Providing means to execute the computer commands;

6. Providing means from inside a first said series of instructions for laboratory scientists and computer commands in claim 1-i to call another said series of human instructions and computer commands in claim 1-i;

7. Providing means to verify the completion of a series of pre-defined instructions and computer commands by an identifiable computer client with the date and time of completion;

8. Providing means to report the status of the said claim 2
Whereby the individual series of instructions for laboratory scientists and computer commands for a laboratory or laboratory-related routines can be designed, customized and implemented;
Whereby the series of instructions for laboratory scientists and computer commands for a laboratory or laboratory-related routines can educate, suggest, guide and prompt the scientists;
Whereby the laboratory managers and scientists can track, monitor and control the quality of the laboratory or laboratory-related routines.
Whereby the laboratory scientists can follow and share the same series of instructions and computer commands to repeat tasks.
Whereby the results and processes of the completion of a series of instructions and computer commands can be documented.
